(19) United States
(12) Patent Application Publication
(10) Pub. No.: US 2019/0229943 A1
(43) Pub. Date: Jul. 25, 2019

(54) SYSTEM AND METHOD FOR CROWDSOURCING GENERALIZED SMART HOME AUTOMATION SCENES

(71) Applicant: PCMS Holdings, Inc., Wilmington, DE (US)

(72) Inventor: Keith Edwards, Atlanta, GA (US)

(21) Appl. No.: 16/326,344

(22) PCT Filed: Aug. 15, 2017
(86) PCT No.: PCT/US2017/046948

§ 371 Date: Feb. 18, 2019

Related U.S. Application Data
(60) Provisional application No. 62/378,051, filed on Aug. 22, 2016.

(51) Int. Cl. H04L 12/28

(52) U.S. Cl. CPC H04L 12/2814; H04L 2012/285; H04L 12/2829; H04L 12/2805

(57) ABSTRACT

Systems and methods are presented for crowdsourcing generalized smart home automation scenes. One embodiment takes the form of a method comprising: receiving a first scene definition comprising a first plurality of destination states for a first plurality of home automation devices, the home automation devices being associated with a location in a first home; for each of the home automation devices: determining a location in the second home corresponding to the location in the first home; identifying an analogous home automation device at that location in the second home; and determining an analogous destination state for the analogous home automation device in second home; storing a second home automation scene comprising the analogous home automation devices and respective analogous destination states; and causing the analogous home automation devices in the second home to operate in the respective analogous destination state upon user selection of the second home automation scene.

### CROSS-REFERENCE TO RELATED APPLICATIONS

The present application is a non-provisional filing of, and claims benefit under 35 U.S.C. § 119(c) from, U.S. Provisional Patent Application Ser. No. 62/378,051, filed Aug. 22, 2016, entitled “System and Method for Crowdsourcing Generalized Smart Home Automation Scenes,” which is incorporated herein by reference in its entirety.

### BACKGROUND

Environments containing a variety of home automation devices and/or services that are remotely controllable have increased in number and complexity. Some example devices include lighting, window shades, alarm systems, home entertainment systems, houseplant and yard watering devices, heating, ventilating, and air conditioning (HVAC) controls, and the like. Homes are environments that have experienced such increases, and homes containing these devices and/or services are sometimes referred to as “smart homes” or “automated homes.” To assist users in the use and configuration of these devices and/or services, scenes are created. The scenes define a collection of devices and the states of the different devices. For example, one scene in a home may turn off some lights, set lighting levels on other lights, and turn on the home theater system. Another scene may be used when the residents are away, and the lights may be turned on or off at certain specified periods of time. In yet another scene, the front door security camera starts recording whenever the front doorbell or a motion sensor near the front door is activated. Generally, the scenes are created at the time of installation of the devices and/or services by a professional installer. Home automation platforms control the devices according to the different scene settings.

### SUMMARY

Systems and methods are presented for crowdsourcing generalized smart home automation scenes. A scene definition having device-specific operational instructions may be translated into a generalized scene pattern having device-class actions or destination states. The generalized scene patterns may then be retrieved at a later point and translated into a new scene definition for a new set of home automation devices by converting the device-class actions into device-specific operational instructions. One embodiment takes the form of a method comprising: discovering home automation devices connected to a network; receiving, from a generalized-scene repository, a generalized-scene pattern having device classes and device-class operations; correlating the discovered home automation devices to the generalized-scene pattern device classes based on home automation device attributes; and generating the specialized scene based on the device correlation.

One embodiment takes the form of a method comprising: receiving a first scene definition comprising a first plurality of destination states for a first plurality of home automation devices, the home automation devices being associated with a location in a first home. For each of the home automation devices: determining a location in the second home corresponding to the location in the first home; identifying an analogous home automation device at that location in the second home; and determining an analogous destination state for the analogous home automation device in second home. A second home automation scene is stored, the scene comprising the analogous home automation devices and respective analogous destination states. In response to a user selecting the second home automation scene, causing the analogous home automation devices in the second home to operate in the respective analogous destination state of the second scene.

Another embodiment takes the form of a method comprising: discovering home automation devices connected to a home network; receiving, from the discovered home automated devices, status-change notifications comprising a time of a status change, a home automated device identification, and a home automated device operation descriptor. Based on the received status-change notifications, a rough-scene definition having specific home automation devices and respective device-specific operations is generated. The home automation devices are correlated to a device class and extrapolated to a rough-scene definition to generate a generalized-scene pattern based on the correlated device class.

### BRIEF DESCRIPTION OF THE DRAWINGS

FIG. 1 depicts a home automation user interface, in accordance with an embodiment.

FIG. 2 depicts a scene creation method, in accordance with an embodiment.

FIG. 3 depicts a system architecture, in accordance with an embodiment.

FIG. 4 depicts a sequence diagram, in accordance with an embodiment.

FIG. 5 depicts a method of scene extrapolation, in accordance with an embodiment.

FIG. 6 depicts a method of scene specialization, in accordance with an embodiment.

FIG. 7 depicts a scene specialization user interface, in accordance with an embodiment.

FIG. 8 depicts a system architecture that includes a scene recorder, in accordance with an embodiment.

FIG. 9 depicts a scene recording process, in accordance with an embodiment.

FIG. 10 depicts a process flow of a scene recording, in accordance with an embodiment.

FIG. 11 depicts a scene specialization user interface for the first use case, in accordance with an embodiment.

FIG. 12 depicts a scene specialization user interface for the second use case, in accordance with an embodiment.

FIG. 13 depicts a method of scene creation, in accordance with some embodiments.

FIG. 14 is an exemplary wireless transmit/receive unit (WTRU) that may be employed as a scene programmer, a home automated device and/or home automation platform in embodiments described herein.

FIG. 15 is an exemplary network entity that may be employed as a home automation system or a networked (e.g. cloud-based) service in some embodiments.

### DETAILED DESCRIPTION

Generally, a home automation platform allows a user to control and configure various devices within a home. Each of the devices is communicatively coupled with the home automation system, either wirelessly (e.g.; Wi-Fi, Bluetooth, NFC, optically, and the like) or wired (e.g.; Ethernet, USB, and the like). The home automation platform is able to receive user inputs for user selected scenes, and provides operational instructions to the devices to implement the selected scene.

The home automation platform is able to receive the user inputs through a user interface (UI). One example of a UI is a speech-based UI, which, in part, allows the user to interact with the home automation platform, with the user's voice (e.g., allows for speech-driven control of the device). For example, the user may interact with the home automation platform by speaking an instruction to the speech-based UI associated with the home automated platform (e.g., embedded in the device, connected to the device), and based on the spoken instruction (e.g., based on the words and/or phrases in the spoken instruction), the device may execute an action corresponding to the instruction. For example, based on the spoken instruction, the home automation platform may execute an action, such as communicating with a device and/or a service, controlling a device and/or a service (e.g., transmitting control commands to a device and/or a service), configuring a device and/or a service, connecting to and/or disconnecting from a device and/or a service, receiving information, requesting information, transmitting information and/or any other suitable action. Other example UIs include a user interacting with a smart phone or computer application that is communicatively coupled to the home automation platform or with a set of buttons on a control panel.

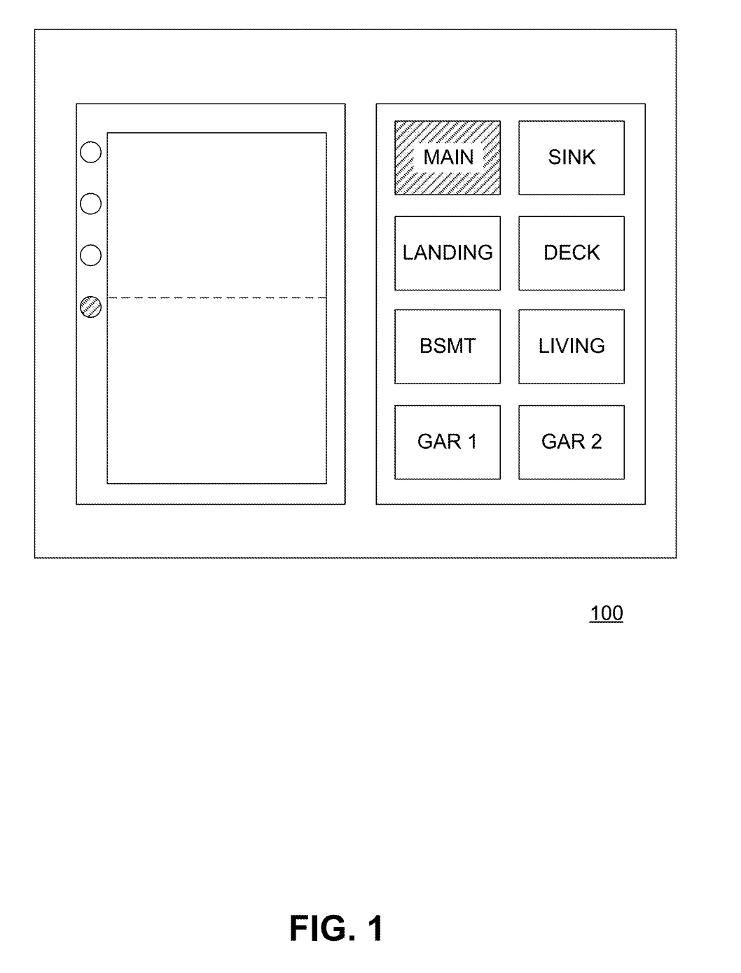

FIG. 1 depicts an example of a home automation user interface. In particular, FIG. 1 depicts the user interface 100 that includes a switch on the left portion and a keypad on the right portion for activating a pre-defined set of scenes. The user interface 100 may be communicatively coupled to different home automation platforms and be able to be configured by the home automation platform. A user may then implement different scenes by selecting different scenes on the user interface 100.

Some speech control devices, and specifically multi-user speech devices such as the Amazon Echo, are increasing in popularity for use in smart-home control. For example, in a smart-home, occupants in a home may issue spoken commands to a speech control device (e.g., a multi-user speech device such as the Amazon Echo® or the 4^{th} generation Apple TV® and/or to a personal device, such as a mobile phone) which may then parse these commands and/or issue control messages over a network to configure smart home devices or other services into a desired state (e.g., turning lights on and/or off; playing movies, music, and/or or other content, etc.). Multi-user speech devices as home-automation controllers (smart-home hubs) may provide a centralized, always-listening, whole-home speech-based UI that may be used any occupant at the home at any time. Moreover, in addition to UI functionality, these multi-user speech devices may serve as a central point of control for connecting with other devices in the home and/or cloud-based services.

Traditionally, developing different scenes could be a detailed process requiring a professional technician to program the home automation platform with technical details of each connected device and state of each device for the different scenes. The technician may utilize a scene programming user interface to program a scene. In some user interfaces, each area of the home is listed, with a sub-menu of devices within each area. One column of the user interface lists the areas, for example, a back driveway area having a back driveway light. Another column displays details of the devices, for example, a “Chandelier” device and includes a name of a switch, the current state of the chandelier, the internet protocol address, and the types of switches as well as different configurable parameters and advanced programming options.

The technical details may include different operating modes, which may be referred to as destination states. The different operating modes could be light intensity and/or color for a light bulb (e.g.; a scene related to brightening a room may require a Phillip Lighting light bulb be set to a brightness of “1.0” and a hue of :0xff68a9ef). In some embodiments, other semantically similar devices may also accomplish the overall desired state of brightening a room. For example, the results of the desired scene, a brightened room, may be accomplished by a home automation platform issuing instructions to a motorized window blind to open the blinds on a window.

Scenes programmed in a traditional method that program specific individual devices in the home may require frequent updating when old home automation devices fail or new home automation devices are introduced into the home. This may require professional expertise to reprogram the scene. Additionally, once a scene is programmed in a traditional method, it may be difficult to export or share to a new home. Because the specific set of devices is “hard coded” into scene definitions, scenes may not be portable across different homes, such that a scene defined for a first home may not be able to be used on another similar home. The homeowner of the second home may have to program the scene from scratch rather than simply copy the scene from the first similar house. Further, with device heterogeneity increasing, maintaining scenes will become more complex. Traditionally, scenes only controlled devices from within a few different categories, such as lighting, shades, retractable projection screens, and limited home security devices. However, with the Internet of Things, many more different types of devices are becoming connected and able to be controlled by home automation platforms.

One traditional method of creating a scene includes a user interacting with a scene programming user interface for a scene programming application. The user creates a new scene in the application and gives it a name, such as “Movie Scene.” The scene programming application discovers all smart home devices on the network and collects details about the devices and presents the devices in a list. For each device, the user selects the device to become part of the scene, and it is added to the scene, by a unique identifier such as a universal device ID (UDID) or a hardware MAC address as part of the scene definition. The user configures the desired settings for each device in the scene, for example, what lighting level should be used, and saves the resulting scene definition as a computer-readable file for later implementation of the scene. Implementing the scene will initiate a specific set of actions on a specific set of devices. The implementation of the scene may not be able to be adapted to new devices entering the home without reprogramming the scene as described above.

In embodiments disclosed herein, various representations of the scenes, from the scene patterns, the scene descriptions, and the like, may be represented in multiple different formats. Different formats include flat text files, JSON files, rows in a database, executable code, XML files, and the like. For simplicity, XML file representations are used in the disclosure.

In accordance with an embodiment, a scene definition may be saved in a computer-readable file, which may be represented as an XML file, such as the following:

```
<scene_definition type=“scene_version_3.2.1” name=“Movie Scene”>
    <device udid=“0xff68a9e4” name=“Living Room Lights”
vers=“Insteon light controller v5”/>
    <device udid=“0x97cf56b2” name=“Hallway Lights” vers=“Insteon
light controller v5”/>
    <action udid=“0xff68a9e4” operation=“setValue” value=“0.0”/>
    <action udid=“0x97cf56b2” operation=“setValue” value=“0.0”/>
</scene>
```

In the above XML file representation of the scene definition, a scene named “Movie Scene” is defined, which includes two devices, the “Living Room Light” (with hardware device ID 0xff68a9e4) and the “Hallway Lights” (with hardware device ID 0x97cf56b2). Two actions are specified to be performed on these devices when the “Movie Scene” scene is activated: the “Living Room Light” and the “Hallway Light” brightness values are both set to “0.0”, turning them off.

The XML file may also include additional steps, such as setting up ‘controllers’ that generate triggering events and ‘responders’ that are triggered when events occur. For example, when a doorbell (acting as a controller) with UDID 0x45fa68A5 is pressed, the camera (acting as the responder) with UDID 0xbc0158cf activates to record a picture of the person at the front door. These events may be represented in an XML file as follows:

```
<scene_definition type=“scene_version_3.2.1” name=37 Doorbell
Security”>
  <device udid=“0x45fa68A5” name=“Front Doorbell” vers=“Insteon
  controller v5”/>
  <device udid=“0xbc0158cf” name= “Security Camera”
  vers=“Insteon controller v5”/>
  <action controller_udid=“0x45fa68A5” responder_udid=“0xbc0158cf”
  value=“record”/>
</scene>
```

In the above XML, the “action” line indicates that when the controller with the specified UDID generates an event, the security camera responder is triggered to begin recording. The controller/responder mechanism allows for basic event-driven programmability in scenes.

In traditional scene creations, the Doorbell Security scene is not adaptable to new devices or new settings. If the specific security camera or doorbell is replaced, the scene will not function as intended because the device's UDID may have changed. This may require reprogramming of the Doorbell Security scene.

In contrast to a traditional device-specific scene, a crowdsourced generalizable smart home automation scene may be used. In one embodiment, a generalized scene pattern is inferred from an existing scene definition. The generalization transforms a scene definition that is created in terms of specific, individual devices into a new representation that can be applied to general classes of devices, potentially on entirely different networks. The generalized scene pattern is a representation of the devices and the respective device actions, but without the ‘hard coded’ binding to the specific device IDs. The generalized scene pattern is thus more flexible, customizable, and reusable as it describes what devices could be used to fulfill a roll in a scene. The generalized scene pattern may then be used to update a scene when the set of devices within the home changes. Alternatively, the generalized scene pattern may facilitate transporting to a new home, even with an entirely different set of devices. Adapting the generalized scene pattern into a new setting may be performed using a specialization process to generate a new scene definition based on the generalized scene pattern.

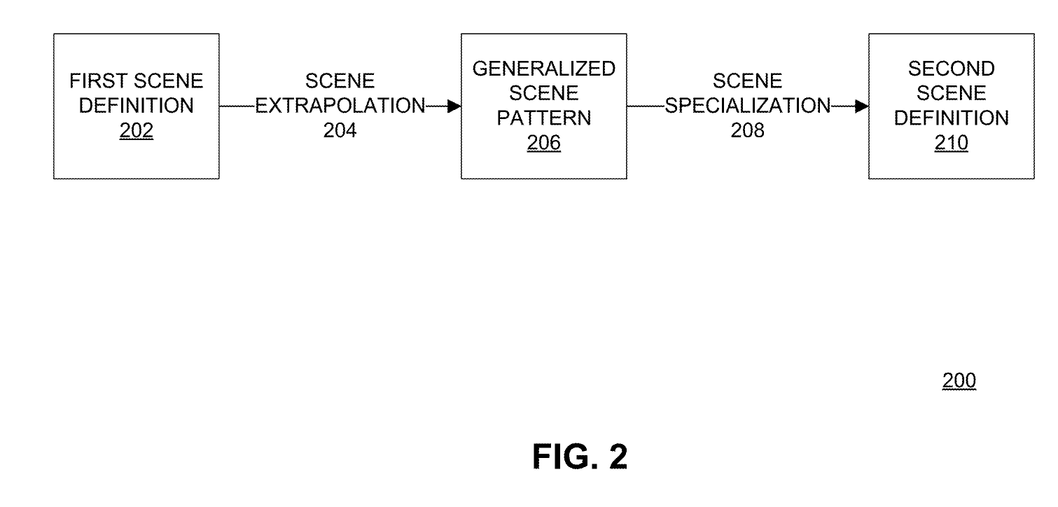

FIG. 2 depicts a scene creation method, in accordance with an embodiment. In particular, FIG. 2 depicts the method 200 that includes a generalized scene pattern 206 that is generated from a first scene definition 202 via a scene pattern extrapolation 204. A second scene definition 210 is then generated from the generalized scene pattern 206 via a scene pattern specialization process 208. In some embodiments, the first scene definition 202 is for a first home and the second scene definition 210 is for a second home. In other embodiments, the first scene definition 202 identifies a first set of devices for a first home, and the second scene definition 210 identifies a second set of devices that is different than the first set for the same first home.

In some embodiments, the second scene definition is produced for the first home. In such embodiments, the second scene definition represents an updated scene definition for the first scene definition. An updated scene definition may be used when replacement home automation devices are added or substituted into the first home or during a malfunction of a home automation device in the first scene definition. In another such embodiment, the second scene definition is generated for a different location within the first home, such as applying the first scene for a first bedroom to the second scene for a second bedroom.

In some embodiments, the scene pattern extrapolation process 204 examines the characteristics of each device in the first scene definition 202 and applies a set of heuristic rules and reviews a user's interaction with the devices to produce a new higher-level representation of the scene that describes the requirements for the devices that make up the scene, rather than specific individual devices. This process may also update the actions in a scene to create generalizable versions of them that may be applied to a wider range of devices. The scene pattern specialization 208 takes the generalized scene pattern 206, discovers a set of devices for the second scene definition, evaluates whether the devices in the second scene can fulfill the roles defined in the generalized scene pattern 206 and selects devices for the second scene definition 210. The second set of devices may be selected from a set of home automation devices at a location that is of the same location type of the first scene.

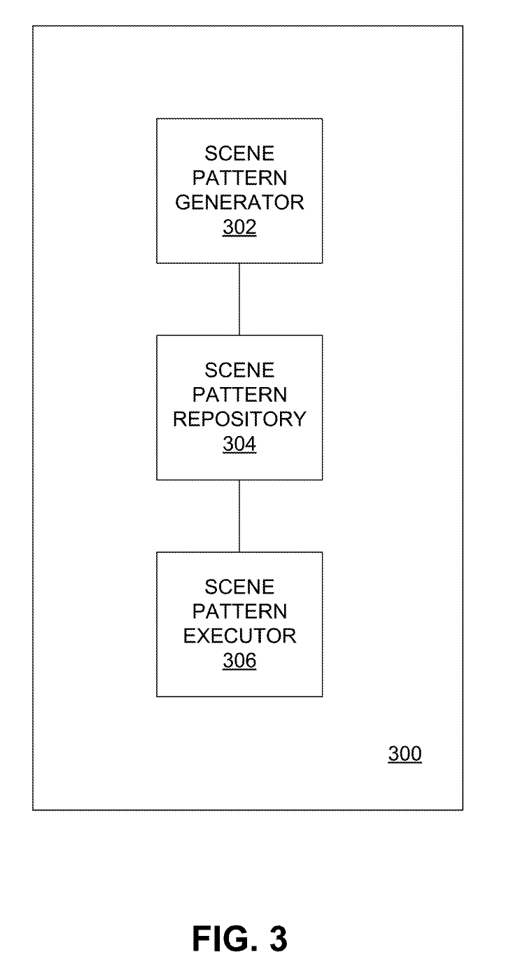

FIG. 3 depicts a system architecture, in accordance with an embodiment. In particular, FIG. 3 depicts the system 300 that includes a scene pattern generator module 302 communicatively coupled to a scene pattern repository module 304, and a scene pattern executor module 306 communicatively coupled to the scene pattern repository 304. The scene pattern generator 302, which may be a computer or mobile device in a first user's home or a server run by a third party, is configured to perform the scene pattern extrapolation 204. When provided with a scene definition, the scene pattern generator creates a generalized scene pattern. The scene pattern repository 304 may be a remote or local computer storage medium that is configured to store collections of the generalized scene patterns and is configured to deliver the generalized scene patterns to other entities upon request, such as in response to a query. The scene pattern executor 306 performs the scene pattern specialization 208 to translate a generalized scene pattern into a new scene definition. Similar to the scene pattern generator 302, this entity may be a computer or mobile device.

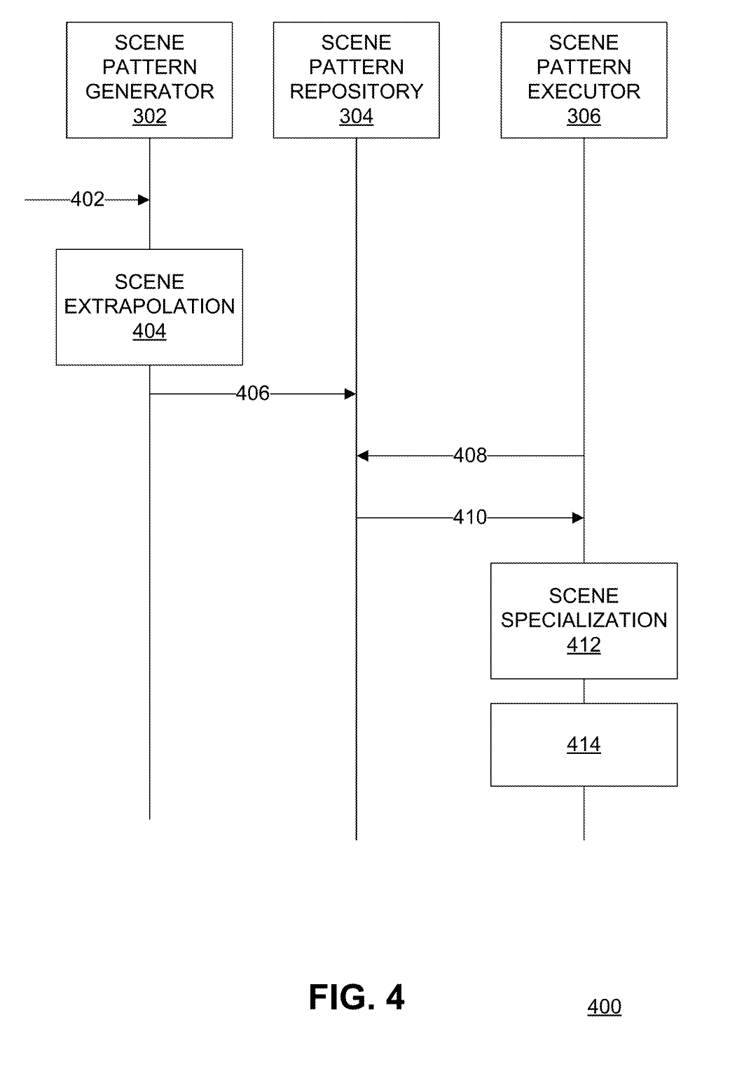

FIG. 4 depicts a sequence diagram, in accordance with an embodiment. In particular, FIG. 4 depicts the sequence diagram 400 that show the communication between the scene pattern generator 302, the scene pattern repository 304, and the scene pattern executor 306 of FIG. 3.

At 402, a scene definition is provided to the scene pattern generator 302. The scene definition may come from any number of sources, for example, it may have been originally created by a professional scene creator, a skilled user with technical skills to configure scenes, a home automation device vendor, a scene pattern stored as a computer-readable file having device identifications and respective destination states for each of the devices, a user demonstrating some series of actions in their own home, or the like. At 404, the scene pattern generator 302 performs a scene extrapolation to construct a generalized scene pattern. The generalized scene pattern may include a device type for each of the home automation devices, a respective destination state, and timing of transitioning each device to its destination state. At 406, the scene pattern generator 302 provides the generalized scene pattern to the scene pattern repository 304. The scene pattern repository 304 may receive generalized scene patterns from numerous different scene pattern generators 302, or it may include generalized scene patterns that were created manually without first being converted from a scene pattern.

At 408, the scene pattern executor 306 queries the scene pattern repository 304 to request generalized scene patterns. In some embodiments, the request is an explicit query, whereby the scene pattern executor delivers a request containing specific attributes that the received generalized scene should include. The request may also be in the form of an installed query that periodically pushes relevant generalized scene patterns to the scene pattern executors 306 from the scene pattern repository 306.

At 410, the scene pattern repository 304 provides one or more of the generalized scene patterns to the scene pattern executor 306. The scene pattern executor 306 performs a scene specialization process 412 to convert the generalized scene pattern into a scene definition for a new set of home automation devices that perform analogous functions as the devices in the first scene. The scene definition is saved and ready to be executed on the local network at 414 to cause the set of devices described in the scene definition to be configured in the manner specified by the scene.

In some embodiments, the scene pattern generator 302 receives a plurality of scene pattern definitions. The process of scene extrapolation comprises aggregating the plurality of scene patterns to determine

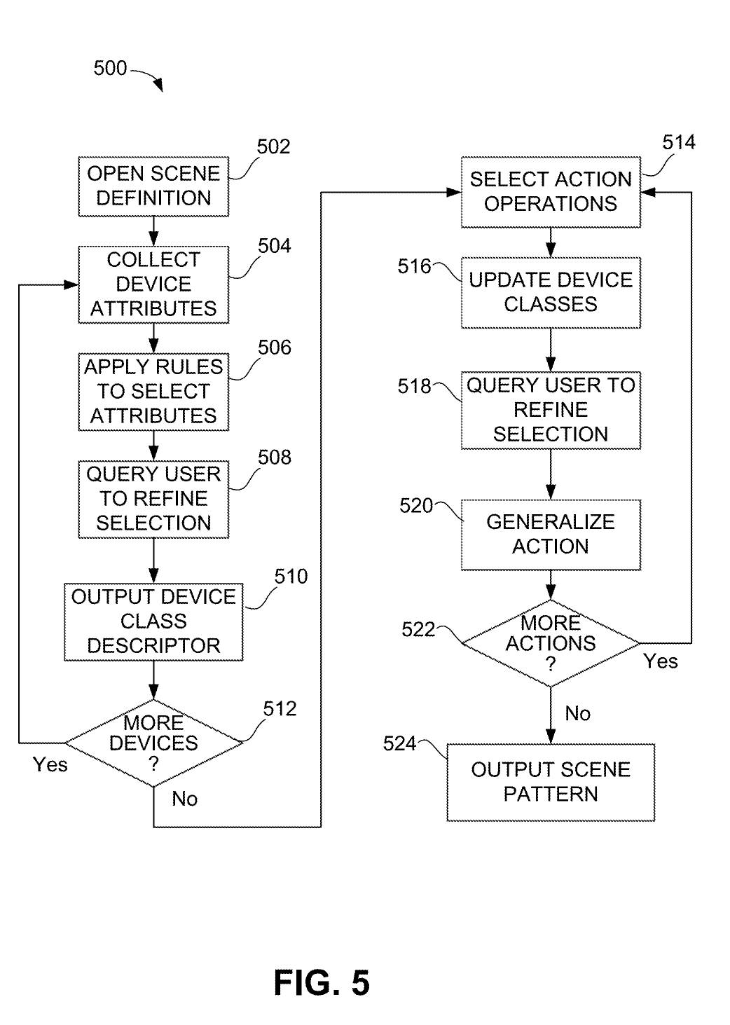

FIG. 5 depicts a method of scene extrapolation, in accordance with an embodiment. In particular, FIG. 5 depicts the method 500, which may be used to perform the scene extrapolation 204 or 404. In the method 500, a scene definition is opened, and then each class of devices required by the scene is described, and locations of the devices, the automation device and automation device destination states in the scene definition are updated to reflect the general device classes. Initially, the method 500 starts by opening the scene definition (502). For each home automation device detected, the attributes (e.g., type, manufacturer, and context) are collected (504). Rules are applied to the salient attributes (506). Optionally, the user is queried (508), via a user-interface, to refine the selection, for example to determine if the attributes are salient to the scene. The device is generalized to a class descriptor (510), and any relevant attributes are tagged as required or optional. The process may be repeated (512) for additional devices.

For all of the actions or destination states in the scene definition, the action operations are selected (514), the device classes are updated (516) to include required action operations. Optionally, the user may be queried (518) to refine the selection, and the actions are generalized (520) to a device class with relevant attributes. This process may be repeated (522) for additional actions. The generalized pattern is then output (524), such as to the scene pattern repository 304.

In the method 500, each home automation device from the opened scene will have multiple attributes associated with it, include its type. For example, a lighting device may have the following attributes, presented in XML format:

```
<device udid=“0xff68a9e4”
    name=“Living Room Lights”
    version=“Insteon light controller v5”
    manufacturer=“Insteon”
    supportsColor=“yes”
    dimmable=“yes”
    location=“Living Room”
    firmwareRevision=“1.0507”
    hoursInUse=“5.21”
    connectivity=“802.11b”/>
```

The lighting device attributes in this example include a human-readable name for the device (Living Room Lights), indicate its manufacturer (Insteon), software version (Insteon light controller v5), that the lights can change color, are dimmable, and are located in the living room. A number of other attributes indicated low-level details, such as the firmware revision of the lights, the number of hours they have been in use since replacement, and the type of physical interface used to communicate with the device (802.11b).

In some embodiments, a portion of the attributes may be considered to be salient in a generalized representation, but others may be considered not to be salient. For example, if a “Game Playing” scene dims the lights and sets them to red, then these requirements are salient for the scene definition, and should be retained in any generalized pattern that is produced. Other attributes, such as the firmware version and hours in use, are less useful to require in the pattern, as they do not affect the functional definition of the scene. During the extrapolation process, the algorithms apply a set of heuristic rules to filter which attributes are salient and should exist in a generalized pattern. The user may also be queried directly to ask which attributes should be retained as salient. For example, the user may be presented, via a user interface, the question: “For this scene, is it important that the lights are dimmable?” The final aspect of generalization is to examine the actions in the scene definition. If an action requires a given capability, for example, the ability to dim the lights, then this capability is considered salient and is retained in the generalized pattern. The generalized pattern contains a description of what specific devices may be used to fulfil the roles in a scene pattern if the scene is run. An example portion of a scene pattern description in XML format follows:

```
<scene_pattern_descriptor name=“Game Playing”>
    <device_class_descriptor id=“1”
        deviceType=“lights”
        requiresColor=“yes”
        requiresDimmable=“optional”
        manufacturer=“any”/>
    <action_descriptor
        device_descriptor_id=“1”
        operation=“setColor” value=“red”
        optional_action=“setDimmed” value=“0.5”/>
</scene_pattern_descriptor>
```

In the above scene pattern description, a generalized description of the task the scene accomplishes is described. The example scene pattern description above indicated that any device that is of the type “lights” and that has a selectable color can fulfill this role in the pattern. This device can be from any manufacturer, and can optionally support dimming, although this is not required. The “action_descriptor” defines what happens when the scene is implemented. Here, the “device_class_descriptor” identifiedby the ID 1 is found, then the “setColor” action is called on to make the light red, then, optionally and if the capability is present, the “setDimmed” action is called to set the light to half brightness.

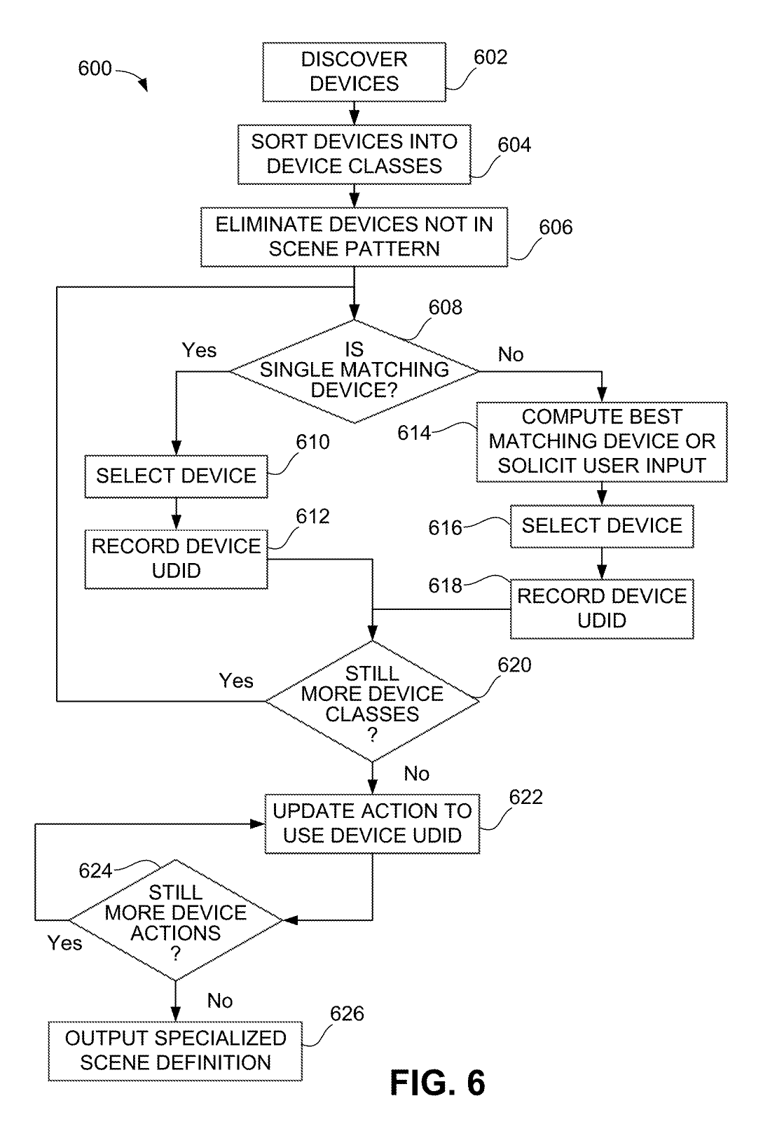

FIG. 6 depicts a method of scene specialization, in accordance with an embodiment. In particular, FIG. 6 depicts the method 600 which may be used to perform the scene specialization 208 or 412. In the method 600, the home automation devices are discovered (602), via a network discovery protocol. The discovered devices are sorted (604) into device classes based on type. The devices of the device class that are included in the scene pattern are collected, and others are discarded (606). For each device class, if only one discovered device exists (608) in the current device class, it is selected (610) and the device's UDID is recorded (612). If multiple discovered devices exist in the current device class, the best matched device (614) as based on the attributes is selected (616) for specialization and the device's UDID is recorded (618). The process may be repeated (620) for additional devices. In an alternative embodiment, the user may be queried for the best matched device to select a device for specialization. The UDID of the selected device is recorded. For each action, the action is updated (622) to use the device UDID previously selected. This process may be repeated (624) for additional device actions. The specialized definition is then output (626). In some embodiments, the discovered devices of 602 are in a location that corresponds to the location of the generalized scene.

The home automation devices are discovered via their respective network discovery protocols (e.g., Zigbee, Bluetooth, UPnP, Wi-Fi and so forth). The discovered devices are sorted into device classes based on the type of device. For example, all lighting devices will be sorted into the Lighting class, all security cameras will be sorted into the Camera class, and so forth. A generalized scene pattern will require select device classes, and the discovered devices that are within the required class are collected and those that not within the required class are discarded.

For each device class that is required, the collected devices are reviewed for selection to fulfill a role in the specialized scene. If there is only one device that meets the requirements of the device class, it is selected to be the actual hardware device that will fulfill this role in the scene pattern. If there are multiple devices that meet the requirement of the device class, then the system may operate to determine which devices should be used. In one process, a fully automated process operates to select the best matched device based on how many attributes of the device match the required and optional attributes from the template. For example, if two lighting devices are found, and one supports both dimming and color, while the other only elects color, the automated selection process may favor the device with both options. In another process, a user interface displays a selection to a user to select the device for the specialization.

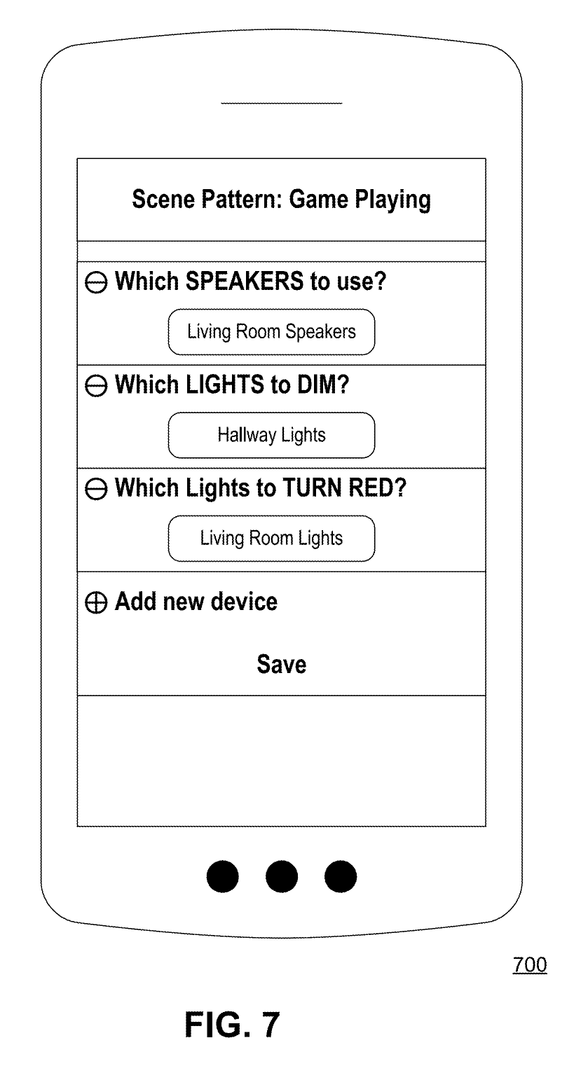

FIG. 7 depicts a scene specialization user interface, in accordance with an embodiment. In particular, FIG. 7 depicts the user interface 700. The user interface 700 is displayed on a mobile device. As shown on the user interface, the scene pattern “Game Playing” is being specialized from a generalized pattern. Multiple devices are a possible match, and the user is presented with devices to select to include in the Game Playing scene. First, the user is presented with a question of “Which SPEAKERS to use?”, with a first selection of “Living Room Speakers” displayed it a drop down box. Second, the user is presented with the question “Which LIGHTS to DIM?”, with a “Hallway Lights” selection, and “Which LIGHTS to TURN RED?” with a selection of “Living Room Lights” displayed. The user interface 700 also includes an option to manually add a new device and to save the inputs to the specialized scene. Once selected, the UDID of the selected devices for each device class are recorded.

The device actions are next processed. For each “action_descriptor” in the generalized pattern, the descriptor is updated to use the UDID of the selected device for that action and updates the operations that the action invokes on the device, based on the device's actual capabilities. The new specialized scene is then output, which includes specific actual devices based on the generalized pattern.

In accordance with some embodiments, device types may be substituted when generating a scene. The substitution may add devices that were not present at the time the first scene was originally created, but are present when the second scene is being generated. The substitution is based on incorporating semantically similar devices, even though those devices may be of different types. For example, in an original scene to darken a room, the first scene definition may contain controls to dim a set of controllable lights in the room. But in a different home, the same effect might be accomplished by lowering computer-controllable blinds over the window. Semantically, these two devices, the lights and blinds, are related, in that they both affect the light level in a room.

Likewise, a first home security scene may have controls to ensure that all doors are locked, and that cameras are configured to detect motion. In a different home, with a different set of home automation devices, a user may wish to develop a second home security scene based on the first home security scene. The user's home may not have cameras, but instead has motion detectors installed. Semantically, there is an equivalence between these two devices. For a home to be secure, one would want to make sure that the doors are locked and garage doors closed. For the purposes of detecting motion, either a camera or a dedicated motion sensor will suffice as they are analogous triggering events, and should trigger the same or an analogous responder event (e.g., a transition to a responder-device destination state). Additionally, the user's home may not have controllable locks but does have a networked garage door opener. Semantically, there is also an equivalence between the controllable locks and the networked garage door opener because for purposes of home security, one would want the doors locked and the garage door shut. Despite being semantically similar, all of these devices would report a different device type if queried over the network.

To develop a specialized scene with semantically similar devices, a semantic database is queried. The semantic database stores equivalence relationships among different devices, and makes them available so that they may be used when a scene is specialized for a given home based on a generalized pattern. In some embodiments, the semantic database is stored remotely and is accessible by many different parties so that the relationships contained within the database can be shared and updated across many different homes. Determining a semantically similar device may also be referred to as determining an analogous home automation device. The analogous home automation device is able to achieve an analogous (semantically similar) destination state as the first home automation device.

When devices are queried, they may return a text string describing the device's type, which may be set into the device's firmware by the device manufacturer. In one form, the semantic database stores tuples in a table that indicate semantic equivalences between these device types. For example, if the device type “Philips Hue Lighting” is considered to be similar to a variety of controllable window blinds by different manufacturers, the table may contain a mapping between the lighting device type and a variety of device types that represent window blinds, such as “Serena Shades”, a type of computer controlled window blind. Notionally, such a relationship may be represented as:

Philips Hue Lighting→Serena Shades

Philips Hue Lighting→Lutron Smart Window Blinds

and as a database table as shown in Table 1, although other database structures are possible, such as keeping reverse mappings that go in opposite directions or keeping separate tables for each device type.

TABLE 1
Semantic Device Relationship Database Table

| Device Type | Equivalence Class |
|---|---|
| Philips Hue Lighting | Serena Shades |
| Philips Hue Lighting | Lutron Smart Window Blinds |

With a semantic database maintained and able to be queried, the method 600 may be modified to sort the devices into classes, to collect devices that are in the class or in a semantically similar class, and to reject the other devices. Thus, using the above example, when a generalized pattern calls for “Philips Hue Lighting”, if either “Serena Shades” or “Lutron Smart Window Blinds” are discovered by the network, they may be used as semantically equivalent devices as the “Philips Hue Lighting” in the creation of a specialized scene. In some embodiments, both a “Philips Hue Lighting” device and a “Serena Shades” device are discovered, and both devices, the exact device match and the semantic device match, are used in the specialized scene. In some embodiments with multiple devices present on the home network, the devices are filtered according to other attributes. For example, both lights and window blinds may be prioritized if they have the same “Location” attribute.

In some embodiments, the semantic substitution extends to the actions or operations taken by the semantically similar devices. As an example, lighting and window shade devices are semantically related. In the case of lights and blinds, dimming the lights has a semantic correspondence with lowering the blinds, and likewise, brightening the lights corresponds with opening the blinds. Notionally, such a relationship is shown as:

Philips Hue Lighting: Dim→Serena Shades: Lower

Philips Hue Lighting: Brighten→Serena Shades: Raise

wherein the strings “Dim,” “Brighten,” “Lower,” and “Raise” are names of the device-specific operations defined by those devices' protocols. This relationship may also be shown in a database table, as shown in Table 2.

TABLE 2
Semantic Device and Operation Relationship Database Table

| | | | Equivalence |
|---|---|---|---|
| Device Type | Operation | Equivalence Class | Operation |
| Philips Hue Lighting | Dim | Serena Shades | Lower |
| Philips Hue Lighting | Brighten | Serena Shades | Raise |

In some embodiments, the scene specialization uses semantic devices and actions as possible substitutes or complementary devices to the generalized pattern. For example, if the list of discovered devices is missing an exact match to a generalized pattern device type, a semantically similar device type may be suggested to the user via a user interface to select the semantically similar device to be in the specialized scene. In another example, if the list of discovered devices includes both the exact match to the generalized pattern device type and also includes semantically similar device types, but the exact match device type and the semantically similar device in the specialized scene definition.

In such a method, the home automation devices may be discovered via a network discovery protocol. The discovered devices are sorted into device classes based on device type, and device classes that are in the scene pattern are collected. For each device class in the scene, semantically equivalent device types that correspond to the device class are retrieved from the semantic database. Additional discovered devices are identified that match the semantically similar class and make up the substitution candidates. In the condition that only one discovered device exactly matches the generalized pattern, it will be selected, otherwise the best match is selected based on attributes or querying the user. Then, the substitute candidates are evaluated to be used with, or instead of, the selected devices. In the condition that no devices on the home network match the scene discovery class, then the user is queried for replacement devices for the original device type. The selected devices have their UDID's recorded, and the operations are further assigned to the devices with recorded UDIDs. If a device in the specialized scene is from the substitute list, the actions are substituted with a semantically similar action or operation and the specialized scene is output for future use.

In an example use case with semantically similar devices, a user first starts by discovering the actual devices that currently exist on the home network, via a standard network discovery process. The discovered devices are grouped into “buckets” based on their type. Next, the generalized scene pattern is analyzed and the scene device classes are extracted from the generalized scene pattern. Discovered devices that match the device class extracted from the generalized scene pattern are used in the specialized scene, and the UDID for those devices are recorded and the actions and operations for that device are stored in the specialized scene. Next, substitution candidates are reviewed to determine an analogous home automation device. The substitution candidates are devices that are semantically similar to the devices in the generalized pattern device class, as determined by a relationship established in the semantic database. For example, a semantically similar, or analogous, device is capable of achieving a similar destination state as the first device. The substitute candidates are evaluated to be included in the specialized scene, and the evaluation is based on a number of device attributes that match the patterns attributes or via a persona response from the user via a user interface. Rather than listing all of the equivalent devices, the substitute devices may be prioritized among those that have matching device attributes, for example selecting blinds with the same, or semantically similar, location attribute as lights.

In accordance with an embodiment, performing scene specialization comprises performing a device type substitution or augmentation based on a semantic analysis of device types at the scene. A generalized scene pattern is specified in terms of a specific type of device to be used, for example a Philips Hue Lighting controller. An exemplary generalized scene pattern is expressed in an XML format below:

```
<scene_pattern_descriptor name=“Good Night”>
    <device_class_descriptor id=“1”
        device_type=“Philips Hue”
        dimmable=“yes”
        color_change=“yes”
        manufacturer=“Philips”/>
    <action_descriptor
        device_descriptor id=“1”
        operation=“setDimmed” value=“0.75”/>
</scene_pattern_descriptor>
```

The generalized scene pattern is translated to a scene definition using semantically similar devices that exist on the home network. A semantically similar device is substituted for device types that appear in the original scene or scene pattern but are not available in the home network. Alternatively, the semantically similar devices may be used in conjunction with the original device types. The device operations are similarly mapped to semantic operations for the respective devices. In one example, the scene pattern identifies a light, such as a Philips Hue light, as the device type. In developing the scene definition, both a Philips Hue Light and window covering, such as a Serena Blind are discovered. The light and the window covering have a relationship established in a semantic database. The Philips Hue Light is included in the scene definition because it is an exact match for the device class. Additionally, the Serena Blind device is included in the scene definition because it is a semantically similar device class. If there was no exact device type match, just the Serena Blind device would have been used in the scene definition. An example scene definition after specialization with semantic device substitution/augmentation in listed below XML format:

```
<scene_definition name=“Good Night”>
    <device udid=“0x45fa68a5” name=“Lights”
        location=“Living Room”
        manufacturer=“Philips”/>
    <device udid=“0xbc0158cf” name=“Blinds”
        location=“Living Room”
        manufacturer=“Serena”/>
    <action_controller_udid=“0x45fa68a5”
        operation=“setDimmed” value=“0.75”/>
    <action_controller_udid=“0xbc0158cf”
        operation=“lower”/>
</scene_definition>
```

In some embodiments, determining semantic equivalent devices is aided by human selections. In one embodiment, semantic relationships are established manually via an explicit process. For example, a vendor, a standards organization, or a third party cloud service may maintain the semantic database and update it regularly as new device types appear on the market. In another embodiment, the semantic relationships may be created via a crowdsourced platform, using an implicit process. In this embodiment, as users adapt scenes to their homes, the network discovery process described above may identify device types that exist on the home network that do not yet have a relationship established in the semantic database. These devices types represent new device types for which semantically equivalent device types should be discovered. Such new semantically equivalent device types that do not yet have a semantic relationship established are presented in the user-interface to prompt a user to classify the new device. The selections from multiple different users may be aggregated before establishing the semantic relationship in the semantic database. This process permits multiple users in multiple houses to provide inputs on which devices should be used together in a scene.

In some embodiments, the generalization and specification processes promote sharing of scene information through extended crowdsourcing. Some examples include a scene pattern repository, such as the scene pattern repository 304, accessible through social media platforms or online forums. The patterns saved in the repository may be advertised and shared via the social media platforms or downloaded from the forums. Specialized online forums may host the scene pattern repository and sort and filter the scenes by device type and category.

In some embodiments, relevant scene patterns are automatically detected from a scene pattern repository and suggested to users. The home network may be scanned to discover applicable home automation devices, and the suggested scene patterns match the devices and capabilities of the home automation devices discovered on the home network.

In some embodiments, relevant scene patterns are suggested based on the location attribute of the detected home automation devices. For example, a home network may discover a projector, and audio system, lights, and window blinds, each with a location attribute of “Conference Room.” One suggested scene pattern may be for a presentation and also include devices that include the “Conference Room” location attribute. The suggested presentation scene pattern may then be specialized into a presentation scene based on the devices in the home network and the generalized scene pattern.

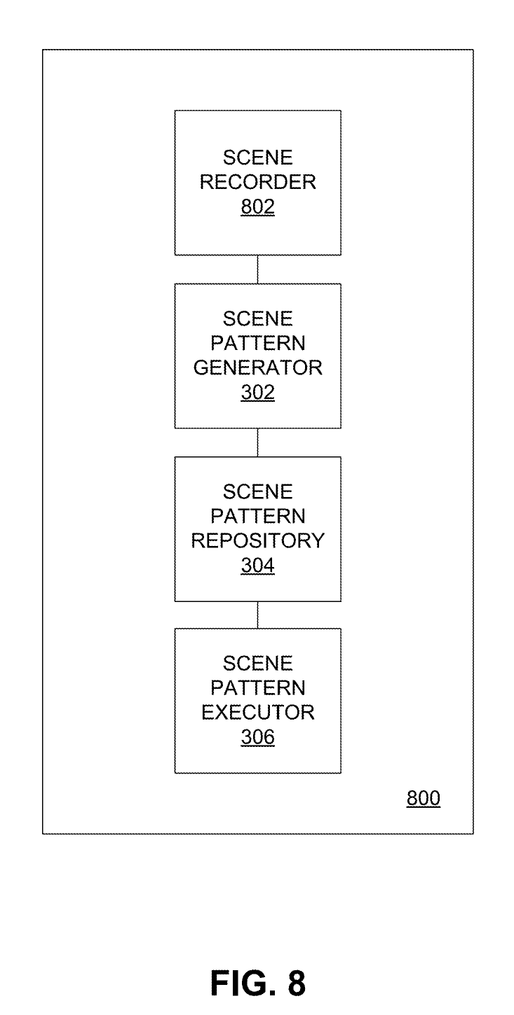

FIG. 8 depicts a system architecture that includes a scene recorder, in accordance with an embodiment. In particular, FIG. 8 depicts the system 800 that includes the elements of the system 300, with a scene recorder 802 communicatively coupled to the scene pattern generator 302. The scene pattern generator 302 is a device or combination of devices similar to the scene pattern generator 302. One such scene recorder 802 is a smart phone having a wireless network connection and configured to discover and communicate with home automation devices.

The scene recorder 802 may be used to record the creation of a scene within a home network. The scene recorder 802 captures changes of state initiated by a user to produce a representation, such as a scene definition, of the operations. The scene definition is then provided to the scene pattern generator 302. In such an embodiment, a user starts a scene recording, and performs operations to establish the desired scene. The scene recorder 802 detects changes in states of the various home automation devices to produce the scene definition that includes the specific devices and the actions performed on those devices. The recording may incorporate the sequence of actions and any time delays.

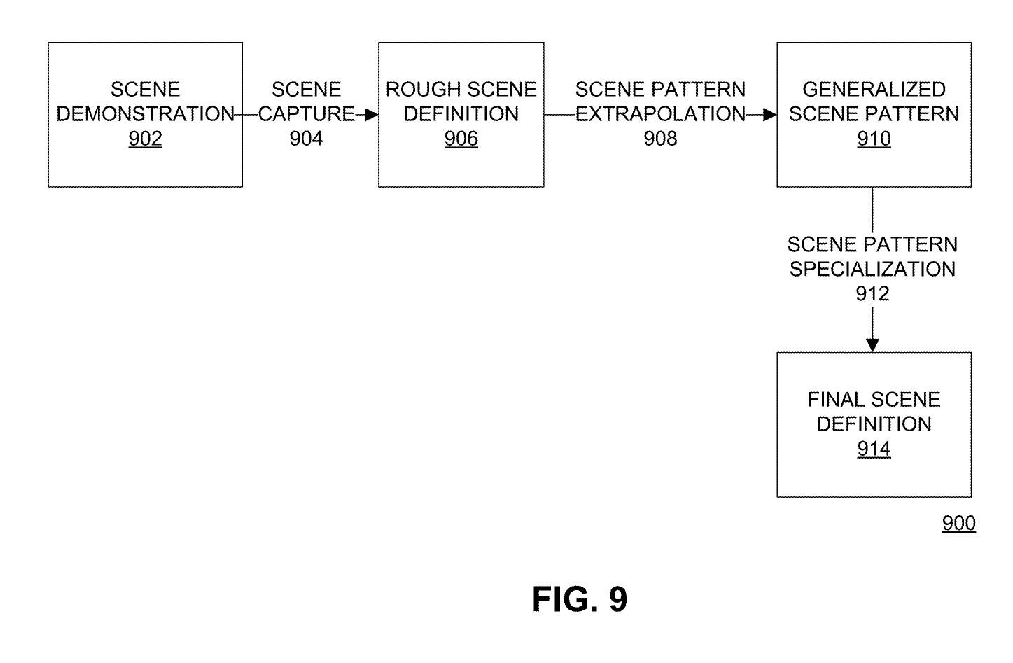

FIG. 9 depicts a scene recording process, in accordance with an embodiment. In particular, FIG. 9 depicts the process 900. In the process 900, a scene demonstration 902 is captured (904) to create a rough scene definition 906. A scene pattern extrapolation (908) is performed to create a generalized scene pattern 910. The generalized scene pattern 910 is specialized (912) to create a final scene definition 914. The process 900 is similar to the process 200, however, instead of starting with the first scene definition 202, the scene recorder 802 records the initial scene definition to create a rough scene definition 906. This rough scene definition is then used to create the generalized scene pattern 910, similar to the generalized scene pattern 206. The rough scene definition 906 is a recording of all of the devices changed states as the user demonstrated at 902 that includes all reported device state changes, sequence and time delays. The scene pattern specialization at 912, may be based on user provided input. This process permits the user to tweak or adjust operation of the specific devices used by each scene. One example of adjusting the scene occurs when new lights or cameras that were not in the original demonstration are added to the home network. It may not be desired for the user to repeat the demonstration for each new camera and light added to the home network. In the demonstration, a light was turned on in response to the motion detector detecting motion. If the house has many motion detectors and lights, a generalized scene may be extracted and then specialized to each different light and motion detector combination.

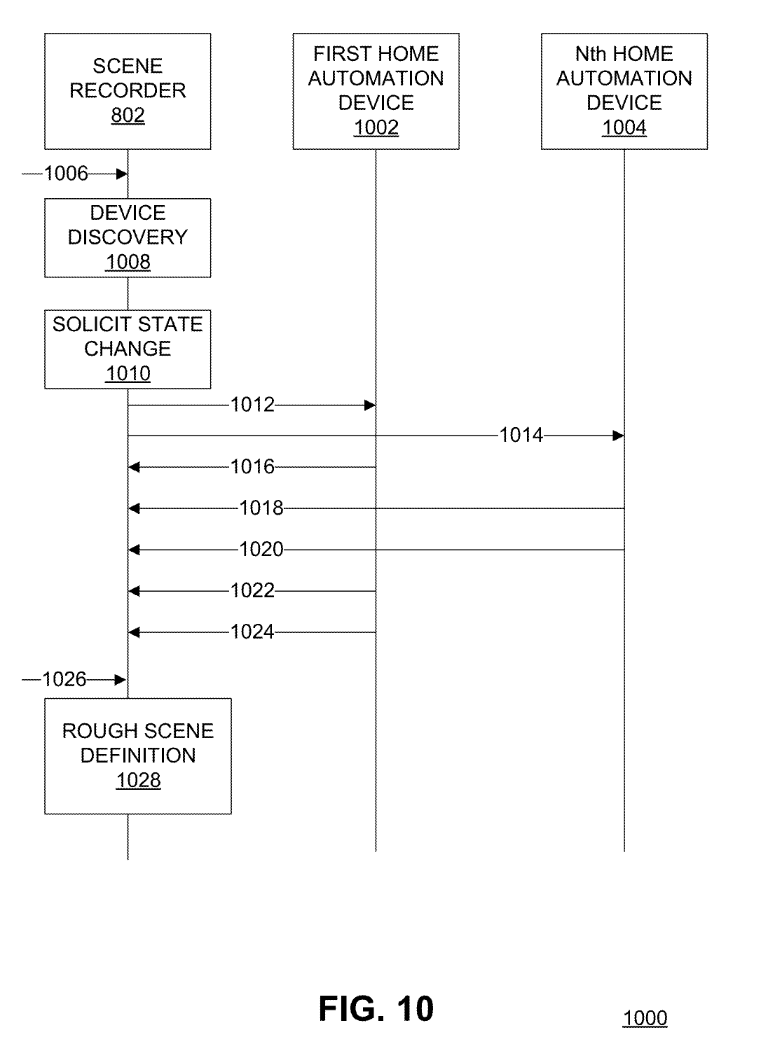

FIG. 10 depicts a process flow of a scene recording, in accordance with an embodiment. In particular, FIG. 10 depicts the process flow 1000 that includes a scene recorder 802 in operation with a first home automation device 1002 and a Nth home automation device 1004. The notation “Nth” is used as any number of home automation devices may be used in a scene recording.

At 1006, the scene recorder 802 receives a “Start Recording” command that indicates that the scene recorder is to solicit state changes from the home automation devices. At 1008, the scene recorder discovers the home automation devices and solicits state changes from the devices 1002 and 1004 by transmitting the ‘solicit state change’ messages 1012 and 1014 to the devices 1002 and 1004, respectively.

The devices 1002 and 1004 are configured to transmit state change messages to the scene recorder 802 that include information regarding the device identification and the operation taken on each device. In the process flow 1000, the state change messages include, in time order, the first home automation device 1002 transmitting a “turned off” state change message 1016, the Nth home automation device 1004 transmitting a “turned off” state change message 1018 and a “motion detected” state change message 1020, and then the first home automation device 1002 transmitting a “turned on” state change message 1022 and a “start recording” state change message 1024. The scene recorder 802 then receives a “Stop Recording” message 1026 and writes the rough scene definition at 1028.

The rough scene created at 1028 (similar to the rough scene definition 906) is then able to be used with a scene pattern extrapolation to produce a generalized scene pattern, which may then be used to produce other scene definitions through specialization. The specialization and generalization enable the salient aspects of the demonstrated scene 902 to be shared. The rough scene may not be appropriate to share, as it may include system specific details that are not relevant to other user's systems and the sequence and delays between the actions may only be incidental to the recording rather than salient. Creating the generalized scene pattern from the rough scene definition may be improved by querying the user, via a user interface, if detected aspects of the scene recording are salient. For example, the user may be presented with the question, “Is ‘Device 1’ required to be turned on before ‘Device 2’ commences recording?” The conversion of the rough scene definition to the generalized scene pattern removes artifacts from the capture process that are not relevant to the overall scene that is used to share scene parameters.

In a first use case, Household A has had a custom installer create a scene for their home security setup. This scene is written especially for the set of devices Household A has paid to have installed, and performs a relatively simple function: when the doorbell is pressed, trigger the front door security camera to begin recording, and turn on the porch lights.

The installer uses a tool, such as a scene programming user interface, to create a scene that might resemble a computer-readable file in the following XML format:

```
<scene_definition type=“scene_version_3.2.1” name=“Doorbell
Security”>
  <device udid=“0x45fa68A5” name=“Front Doorbell” vers=“Insteon
  controller v5”/>
  <device udid=“0xbc0158cf” name=“Security Camera” vers=“Insteon
  controller v5”/>
  <device udid=“0xcdf587ef” name=“Porch Lights” vers=“Insteon
  controller v5”/>
  <action controller_udid=“0x45fa68A5” responder_udid=“0xbc0158cf”
operation=“record”/>
  <action controller_udid=“0x45fa68A5” responder_udid=“0xcdf587ef”
operation=“setValue” value=”1.0/>
</scene>
```

Here, the scene is called “Doorbell Security” and defines three devices that play a role in the scene: Front Doorbell, Security Camera, and Porch Lights. The “action” lines indicate that when the Front Doorbell (defined by its UDID) generates an event, the Security Camera and Porch Lights should act as a responder for this event, and begin recording, or turn on the lights, respectively.

After installation, a user in Household A may purchase an application, based on the technology in this disclosure, which provides the scene generalization/specialization capabilities described herein. The user may run the application, which processes this scene to create a generalized version of it. This generalized scene pattern might be expressed in XML such as the following:

```
<scene_pattern_descriptor name=“Doorbell Security”>
    <device_class_descriptor id=“1”
        deviceType=“doorbell”/>
    <device_class_descriptor id=“2”
        deviceType=“lights”
        requiresColor=“no”
        requiresDimmable=“no”
        manufacturer=“any”/>
    <device_class_descriptor id=“3”
        deviceType=“camera”
        requiresNightVision=“no”
        requiresHighDef=“preferred”
        requiresMotionDetection=“preferred”
        manufacturer=“any”/>
    <action_descriptor
          controller_device_descriptor_id=“1”
          responder device_descriptor_id=“2”
          operation=“setValue” value=“1.0”>
    <action_descriptor
          controller_device_descriptor_id=“1”
          responder_device_descriptor_id=“3”
          action=“startRecording” >
</scene_pattern_descriptor>
```

This generalized scene pattern effectively specifies that any doorbell can be connected to a set of lights, and a security camera. Ideally, the security camera should be high-definition and with motion detection, but any will work. When the doorbell is triggered, the lights are turned on and the camera begins recording.

This generalized scene pattern has enough detail describing the general requirements of the scene, and the devices and actions that comprise it, that it can be downloaded by Household B and “retargeted” for their environment. When the generalized scene is downloaded, the residents of Household B go through a one-time process (e.g., using a UI similar to the user interface 700 depicted in FIG. 7) to adapt the generalized scene pattern to their specific environment.

Household B's smart home installation, however, is quite different than Household A's. For one thing, Household B has different makes and models of the various devices involved in the scene. These devices also have different names from the names that Household A has given their devices. And finally, Household B in this example has additional devices that might usefully play a role in this scene.

The scene specialization UI leads the users in Household B through the process of adapting the generalized scene pattern to a specialized scene definition. First, it discovers a single connected doorbell, and automatically fills it in as the doorbell (called just “Doorbell”) that will be used as the controller in the scene. Next, the UI discovers several smart lights in the home, named “Kitchen”, “Dining Room,” “Gaslight,” and “Back Porch.” The UI suggests that “Gaslight” might be the preferred light to use, since through its discovery process and examining the attributes on the devices, it sees that both the “Doorbell” and “Gaslight” devices have the same location tag, “Front of House.” The user selects this as the light to be used in the scene.

Finally, Household B has a number of security cameras: “Front”, “Driveway”, “Back Porch,” “Side of House”. The scene specialization UI discovers all of these and presents them to the user. In this case, the user knows the positioning of the cameras, and so selects two cameras to be responders to the doorbell event: “Front” and “Driveway”, since these both capture the front region of the home.

Through this process, the original scene from Household A has not only been generalized so that it can be applied to new home network configurations, it has been adapted by Household B to use a completely different set of devices, and even different numbers of devices, via the combination of information in the original scene, and the generalization/specialization algorithms.

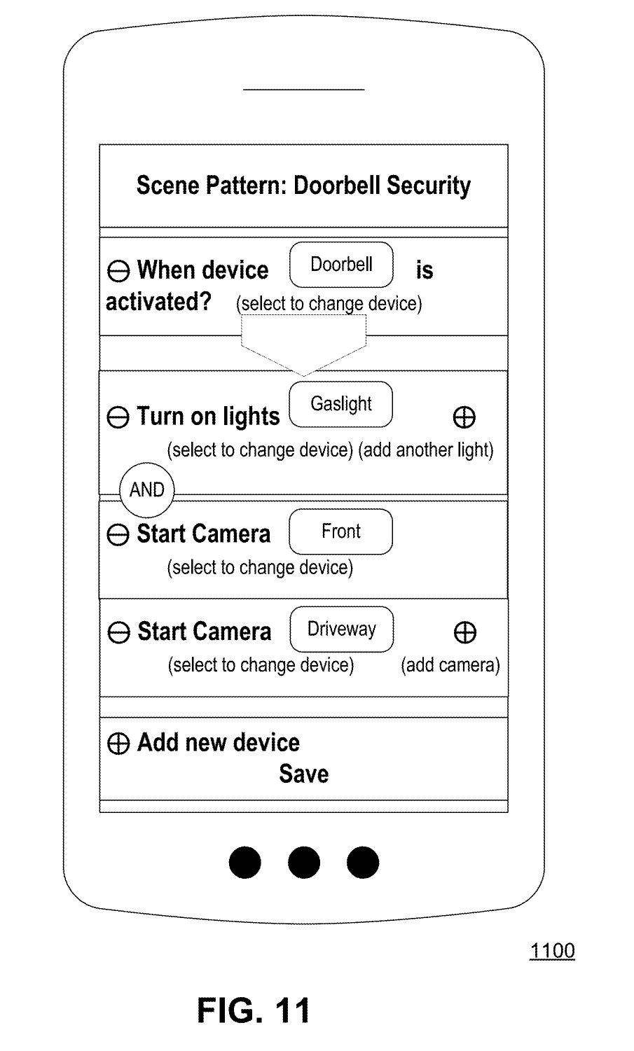

FIG. 11 depicts a scene specialization user interface for the first use case, in accordance with an embodiment. In particular, FIG. 11 depicts a scene specialization user interface 1100 that may be used by Household B in the above use case.

In a second use case, a user creates a scene through scene demonstration and recording mechanisms (e.g., the scene recorder 802). In the second use case, a user wishes to create an “Arriving at Home” scene, which would be triggered whenever the user returns from work, perhaps in response to a controller home automation device detecting a triggering event. The scene recorder detects the transitions to destination states by the various home automation device. It may also detect a triggering event by a trigger-home automation device and a subsequent change to a destination state by a responder-home automation device. In this example, the user intends to have some of the home lights come on, have other lights dimmed, the heater activated, and the garage door closed automatically whenever the scene is activated. In some embodiments, the scene is activated by detection of motion from a motion detector home automation device. Thus, in a subsequent scene developed based on this recording, an analogous controller device capable of detecting an analogous triggering event (e.g., a camera in the first home detecting motion in a video and an analogous motion detector detecting an analogous triggering event of motion by the motion detector) may cause an analogous responder device to transition to an analogous destination state.

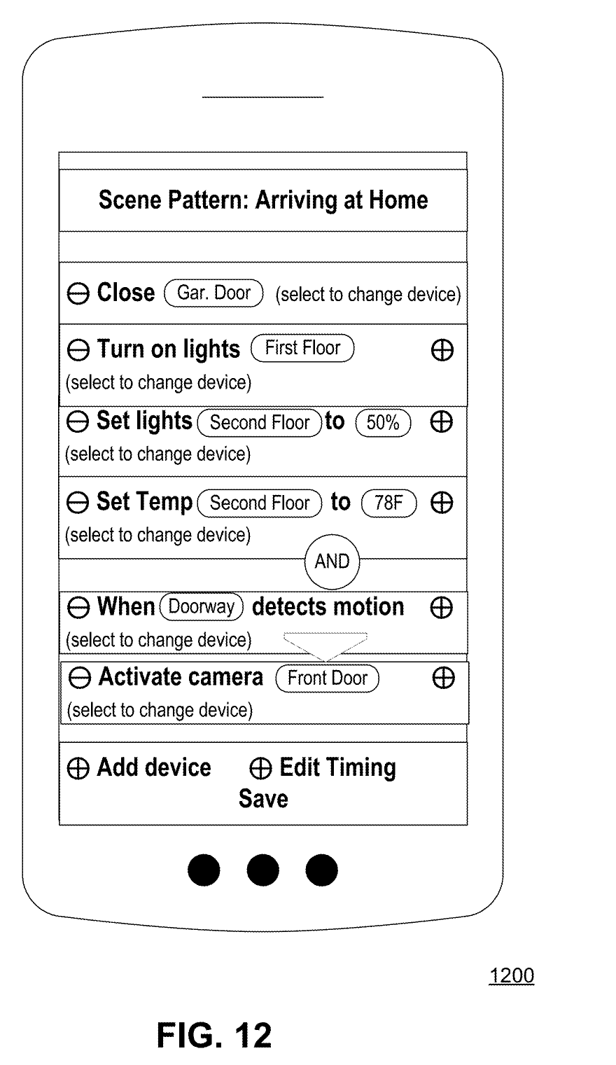

FIG. 12 depicts a scene specialization user interface for the second use case, in accordance with an embodiment. In particular, FIG. 12 depicts the user interface 1200 that is used in by the user in the second use case.

In one embodiment, the user proceeds to record a demonstration of this scene. He hits the RECORD button in his smart phone application, and then walks around the home to set the devices into the various desired states. The press of the RECORD button signals the Scene Recorder to begin executing the steps in the algorithm of FIG. 10, to include running a network discovery process to collect an up-to-date list of the devices in the home, and then soliciting state change events from each of them.

The user starts in the garage and closes the garage door. The Chamberlain MyQ garage door opener detects this change in its state, and relays that information to the Scene Recorder as an event, which is then recorded by the Scene Recorder. This record contains information about the specific device that generated the event, the timestamp of the event, and the state change that occurred (DOOR_CLOSED).

Next, the user walks through the first floor, turning on the Belkin Wemo network-connected lights; this process again causes events to be generated which are captured by the Scene Recorder. The user proceeds to the second floor and dims the lights there, and finally sets the Nest thermostat to begin heating the house to a particular temperature. As this process occurs, the Scene Recorder has captured the specific details about these actions, and recorded them as a rough scene

Next, this rough scene may be played back exactly as it is. This would cause the same specific set of actions to occur in the order, and potentially with the timing, that the user used in his demonstration. And in some cases, this may be desirable—a user may wish to create a scene that does exactly what the user does, in the same order, and even with the same timing. But in other situations—such as this “Arriving at Home” scene, some fine-tuning may be desirable in order to make the scene perform as desired.

For example, the user may wish to have the lighting state changes happen at the same time, rather than in the order that he walked through the home. He may wish the heating to start first, even though it was the last setting demonstrated, since it takes a while for the heat to come on. In most complex scenes, the demonstration itself will likely be insufficient to capture precisely what the user desires, and so it may be desirable to fine-tune the scene. In addition to these timing dependencies—which the user may or may not wish to maintain—there may also be causal dependencies. For example, if a user waves his hand in front of a motion sensor and then turns on the camera, this may be an indication from the user that when motion is detected, the camera should be activated, or it may merely be the case that the user happened to walk in front of the motion detector on his way to turning on the camera. Where there is ambiguity about the interpretation of a user gesture, the system may operate to extract possible relationships between devices and then query the user as to what relationship, if any, was intended to be selected.

The user interface 1200 shown in FIG. 12 displays the generalized form of the rough scene, allowing the user to modify the scene as desired. The user would then fine tune the details here, indicating that the light activation should be done simultaneously, and re-ordering actions so that the thermostat is activated first. The user may also confirm that there should be a causal relationship between detecting motion and activating a camera, rather than just a temporal relationship between these. In the user interface 1200, the “arrow” indicates that the camera door should be activated in response to detecting motion at the motion sensors, as established by the intentional act during the demonstration, rather than a causal act detected during the demonstration.

The result is a scene that works in the user's home that is a product of human demonstration, coupled with computational feature extraction, and then finally tuned and confirmed by the user.

In the second use case, a home is equipped with various home automation devices. The view includes the security camera, the thermostat, the garage door, the upstairs lights, the downstairs lights, the Apple TV HomeKit Server and the Amazon Echo. The devices may be from different equipment from many vendors

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

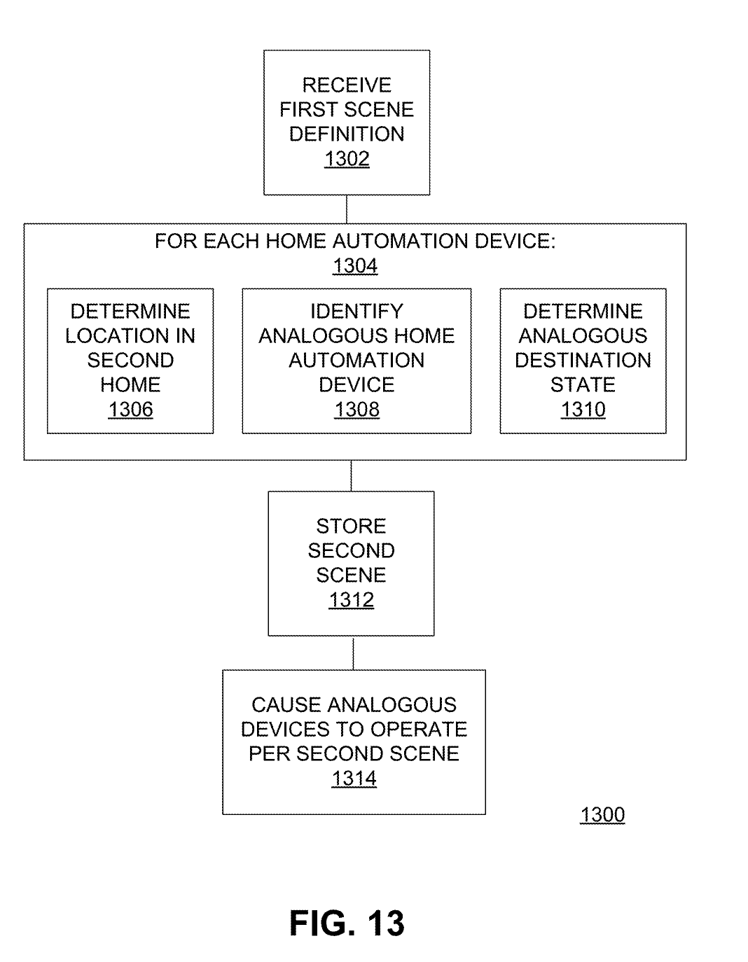

FIG. 13 depicts a method of scene creation, in accordance with some embodiments. In particular, FIG. 13 depicts the method 1300 that includes receiving a first scene definition at 1302, at 1304, for each of the home automation devices in the first scene, determining a location in the second home (1306), identifying an analogous home automation device (1308) at that location in the second home, and determining an analogous destination state (1310) for the analogous home automation device, storing a second home automation scene comprising the analogous home automation devices and their respective analogous destination states at 1312, and causing the analogous devices to operate per the respective analogous destination states (1314) in response to a user's selection of the second home automation scene.

At 1302, a first scene definition is received. The first scene definition comprises a first plurality of destination states for a first plurality of home automation devices. The home automation devices are associated with a location in the first home. The first scene definition can be received from multiple different sources. For example, the first scene definition may be a computer-readable file that includes device identifications, device locations, and device destination states. The first scene definition may also be a generalized scene definition, that includes an output device class descriptor and a generalized destination state for each of the device types. The generalized scene definition may be created by a scene extrapolation process, such as the scene extrapolation 204. In some embodiments, the first scene definition is generated by a scene recorder, similar to the scene recorder 802. The scene recorder records the sequence of changes in states of the different home automation devices and any time delays between the changes.

At 1304, for the home automation devices of the first scene, the steps 1306-1310 are performed to identify an analogous home automation device that is able to achieve a respective analogous destination state at a location in the second home. At 1306, a location in the second home is determined that corresponds to a location of the first scene. At 1308, an analogous home automation device at the second home's location is identified, and at 1310, an analogous destination state is determined for the analogous home automation device. The analogous home automation device is able to achieve a semantically similar destination state as the home automation device of the first scene. Determining the analogous home automation device and the respective analogous destination state may be performed by the methods disclosed herein. For example, the process may include performing scene extrapolation per the method 500 of FIG. 5 and performing scene specialization per the method 600 of FIG. 6. Additionally, identifying analogous home automation devices and respective analogous destination states may be performed by querying a semantic database.

At 1312, a second home automation scene is stored that comprises the analogous home automation devices and the respective analogous destination states. At 1314, the analogous home automation devices in the second home operate in the respective analogous destination states upon user selection of the second home automation scene.

In some embodiments, the second home automation scene may be edited by a user. For example, the user may select a different analogous home automation device, a different analogous destination state, a different transition timing and the like. Example interfaces to edit a scene may be those disclosed in FIGS. 11-12. Thus, in response to the user selecting the second scene, the analogous home automation devices operate per their analogous destination states of the edited second scene.

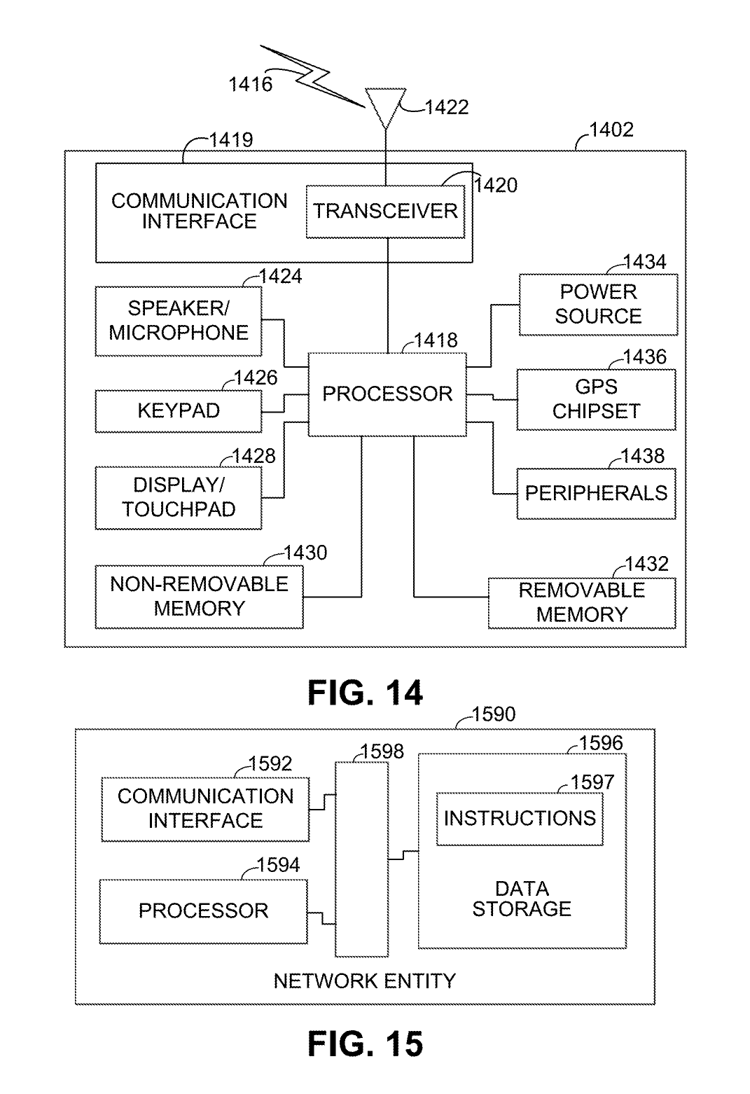

FIG. 14 is a system diagram of an exemplary wireless/transmit receive unit (WTRU) 1402, which may be employed as a scene programmer, a home automated device and/or home automation platform in embodiments described herein. As shown in FIG. 14, the WTRU 1402 may include a processor 1418, a communication interface 1419 including a transceiver 1420, a transmit/receive element 1422, a speaker/microphone 1424, a keypad 1426, a display/touchpad 1428, a non-removable memory 1430, a removable memory 1432, a power source 1434, a global positioning system (GPS) chipset 1436, and sensors 1438. It will be appreciated that the WTRU 1402 may include any sub-combination of the foregoing elements while remaining consistent with an embodiment.

The processor 1418 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 1418 may perform signal coding, data processing, power control, input/output processing, and/or any other functionality that enables the WTRU 1402 to operate in a wireless environment. The processor 1418 may be coupled to the transceiver 1420, which may be coupled to the transmit/receive element 1422. While FIG. 14 depicts the processor 1418 and the transceiver 1420 as separate components, it will be appreciated that the processor 1418 and the transceiver 1420 may be integrated together in an electronic package or chip.

The transmit/receive element 1422 may be configured to transmit signals to, or receive signals from, a base station over the air interface 1416. For example, in one embodiment, the transmit/receive element 1422 may be an antenna configured to transmit and/or receive RF signals. In another embodiment, the transmit/receive element 1422 may be an emitter/detector configured to transmit and/or receive IR, UV, or visible light signals, as examples. In yet another embodiment, the transmit/receive element 1422 may be configured to transmit and receive both RF and light signals. It will be appreciated that the transmit/receive element 1422 may be configured to transmit and/or receive any combination of wireless signals.

In addition, although the transmit/receive element 1422 is depicted in FIG. 14 as a single element, the WTRU 1402 may include any number of transmit/receive elements 1422. More specifically, the WTRU 1402 may employ MIMO technology. Thus, in one embodiment, the WTRU 1402 may include two or more transmit/receive elements 1422 (e.g., multiple antennas) for transmitting and receiving wireless signals over the air interface 1416.

The transceiver 1420 may be configured to modulate the signals that are to be transmitted by the transmit/receive element 1422 and to demodulate the signals that are received by the transmit/receive element 1422. As noted above, the WTRU 1402 may have multi-mode capabilities. Thus, the transceiver 1420 may include multiple transceivers for enabling the WTRU 1402 to communicate via multiple RATs, such as UTRA and IEEE 802.11, as examples.

The processor 1418 of the WTRU 1402 may be coupled to, and may receive user input data from, the speaker/microphone 1424, the keypad 1426, and/or the display/touchpad 1428 (e.g., a liquid crystal display (LCD) display unit or organic light-emitting diode (OLED) display unit). The processor 1418 may also output user data to the speaker/microphone 1424, the keypad 1426, and/or the display/touchpad 1428. In addition, the processor 1418 may access information from, and store data in, any type of suitable memory, such as the non-removable memory 1430 and/or the removable memory 1432. The non-removable memory 1430 may include random-access memory (RAM), read-only memory (ROM), a hard disk, or any other type of memory storage device. The removable memory 1432 may include a subscriber identity module (SIM) card, a memory stick, a secure digital (SD) memory card, and the like. In other embodiments, the processor 1418 may access information from, and store data in, memory that is not physically located on the WTRU 1402, such as on a server or a home computer (not shown).

The processor 1418 may receive power from the power source 1434, and may be configured to distribute and/or control the power to the other components in the WTRU 1402. The power source 1434 may be any suitable device for powering the WTRU 1402. As examples, the power source 1434 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 1418 may also be coupled to the GPS chipset 1436, which may be configured to provide location information (e.g., longitude and latitude) regarding the current location of the WTRU 1402. In addition to, or in lieu of, the information from the GPS chipset 1436, the WTRU 1402 may receive location information over the air interface 1416 from a base station and/or determine its location based on the timing of the signals being received from two or more nearby base stations. It will be appreciated that the WTRU 1402 may acquire location information by way of any suitable location-determination method while remaining consistent with an embodiment.

The processor 1418 may further be coupled to other peripherals 1438, which may include one or more software and/or hardware modules that provide additional features, functionality and/or wired or wireless connectivity. For example, the peripherals 1438 may include sensors such as an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 15 depicts an exemplary network entity 1590 that may be used in embodiments of the present disclosure, for example as an exemplary communications device, various device databases and repositories, and the like. As depicted in FIG. 15, network entity 1590 includes a communication interface 1592, a processor 1594, and non-transitory data storage 1596, all of which are communicatively linked by a bus, network, or other communication path 1598.

Communication interface 1592 may include one or more wired communication interfaces and/or one or more wireless-communication interfaces. With respect to wired communication, communication interface 1592 may include one or more interfaces such as Ethernet interfaces, as an example. With respect to wireless communication, communication interface 1592 may include components such as one or more antennae, one or more transceivers/chipsets designed and configured for one or more types of wireless (e.g., LTE) communication, and/or any other components deemed suitable by those of skill in the relevant art. And further with respect to wireless communication, communication interface 1592 may be equipped at a scale and with a configuration appropriate for acting on the network side—as opposed to the client side—of wireless communications (e.g., LTE communications, Wi-Fi communications, and the like). Thus, communication interface 1592 may include the appropriate equipment and circuitry (perhaps including multiple transceivers) for serving multiple mobile stations, UEs, or other access terminals in a coverage area.

Processor 1594 may include one or more processors of any type deemed suitable by those of skill in the relevant art, some examples including a general-purpose microprocessor and a dedicated DSP.

Data storage 1596 may take the form of any non-transitory computer-readable medium or combination of such media, some examples including flash memory, read-only memory (ROM), and random-access memory (RAM) to name but a few, as any one or more types of non-transitory data storage deemed suitable by those of skill in the relevant art could be used. As depicted in FIG. 15, data storage 1596 contains program instructions 1597 executable by processor 1594 for carrying out various combinations of the various network-entity functions described herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method of adapting a home automation scene for a first home to a second home, the method comprising:
receiving a first scene definition comprising a first plurality of destination states for a first plurality of home automation devices, each home automation device in the first plurality of home automation devices being associated with a location in a first home;
for each of the first plurality of home automation devices:
determining a location in the second home corresponding to the location in the first home;
identifying an analogous home automation device at the determined location in the second home, wherein identifying an analogous home automation device comprises querying a semantic database to identify a home automation device capable of achieving a similar destination state as the home automation device in the first scene definition; and
determining an analogous destination state for the analogous home automation device in second home;
storing a second home automation scene definition comprising the analogous home automation devices and respective analogous destination states; and
causing the analogous home automation devices in the second home to operate in the respective analogous destination state upon user selection of the second home automation scene.

2. The method of claim 1, wherein the first scene definition is a computer-readable file comprising a home automation device identification and a respective destination state for each home automation device in the first plurality of home automation devices.

3. The method of claim 1, wherein the first scene definition comprises a device class descriptor and a generalized destination state for each home automation device in the first plurality of home automation devices.

4. The method of claim 1, further comprising a scene recorder capturing a transition to the destination state for the respective home automation devices in the first plurality of home automation devices and generating the first scene definition based on the captured transitions.

5. The method of claim 4, the scene recorder further capturing a time for each home automation device transition; and wherein the second home automation scene comprises a schedule for transitioning the analogous home automation devices to respective analogous destination states in a time order based on the captured time of transitions.

6. The method of claim 4, further comprising:
the scene recorder detecting a triggering event from a controller-home-automation device and a subsequent transition to a responder-destination state by a responder-home-automation device;
identifying an analogous controller-home-automation device having an analogous triggering event in the second home; and
identifying an analogous responder-home-automation device and a respective analogous responder-device destination state;
wherein the second home automation scene definition further comprises the analogous responder-home-automation device transitioning to the analogous responder-device destination state responsive to the analogous controller-home-automation device detecting the analogous-triggering event.

7. The method of claim 1, wherein determining a location in the second home corresponding to the location in the first home comprises determining a generalized location type for the location in the first home, and identifying a location in the second home that is of the same determined generalized location type.

8. (canceled)

9. The method of claim 1, further comprising a user editing the second scene, and the analogous home automation devices and respective analogous destination states of the second scene operating per the edited second scene.

10. The method of claim 1, wherein at least one device in the second plurality of devices is a light.

11. The method of claim 1, wherein at least one device in the second plurality of devices is a window covering.

12. The method of claim 1, wherein at least one device in the second plurality of devices is a lock.

13. The method of claim 1, wherein the first scene comprises a light home automation device with a destination state of on, and the respective analogous home automation device is a window cover with an analogous destination state of open.

14. A home automation system comprising a processor and a non-transitory computer storage medium storing instructions operative, when executed on the processor, to perform functions comprising:
receiving a first scene definition comprising a first plurality of destination states for a first plurality of home automation devices, each home automation device in the first plurality of home automation devices being associated with a location in a first home;
for each of the home automation devices:
determining a location in the second home corresponding to the location in the first home;
identifying an analogous home automation device at that location in the second home, wherein identifying an analogous home automation device comprises querying a semantic database to identify a home automation device capable of achieving a similar destination state as the home automation device in the first scene definition; and
determining an analogous destination state for the analogous home automation device in second home;
storing a second home automation scene definition comprising the analogous home automation devices and respective analogous destination states; and
causing the analogous home automation devices in the second home to operate in the respective analogous destination state upon user selection of the second home automation scene.

15. The home automation system of claim 14, wherein identifying an analogous home automation device comprises detecting a set of home automation devices in the second home and selecting the analogous home automation devices from the detected set.
